(19) United States
(12) Patent Application Publication
(10) Pub. No.: US 2005/0143154 A1
(43) Pub. Date: Jun. 30, 2005

(54) Method of engaging in basketball shooting contest from different locations

(76) Inventor: James Robert Bush, Hulett, WY (US)

Correspondence Address: James R. Bush, 447 Grazing Association RD, Hulett, WY, 82720-9642, US

(21) Appl. No.: 10/826,123

(22) Filed: Apr. 15, 2004

Related U.S. Application Data
(60) Provisional application No. 60/463,193, filed on Apr. 15, 2003.

(51) Int. Cl. A63F 13/00

(52) U.S. Cl. 463/4

(57) ABSTRACT

A method utilizing basketball rebounders, network connections, various sensors, video cameras, and output monitors to allow basketball shooters to engage in shooting competitions with one another without being in the same physical location.

### CROSS REFERENCE TO RELATED APPLICATIONS

Provisional Patent No. 60/463,193

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

One of the problems with engaging in the various basketball contests is that both participants must be in the same physical location. This limits the competitive pool available to the players. In addition many times it requires one or both contestants to travel long distances to engage in competition. For example at my home high school the closest conference competitors were over 100 miles in distance. Weather, bus drivers, travel time, buses, and fuel are a few of the expenses that act to limit the amount of competition players might like to participate in.

U.S. Pat. Nos. 5,114,115 and 6,430,453 create methods for transporting the game model of Darts and Bowling to the network. Although both methods allow for transporting a game model to the Network, neither mentions basketball. I believe this is because in both Darts and Bowling there is not an active defense trying to interfere with the shooter (darts) or bowler. The main basketball game model uses an active defense. However, there are basketball games that do not use an active defense such as Horse, Pig or Around the World. In addition there are other possibilities of game models that use shooting skill as the sole determinant of victory.

U.S. Pat. No. 6,389,368 is for a video analysis system that detects successful/unsuccessful shots as well as distance from basket of shots. This patent also references the fact that shooting contests can take place remotely over a network or the Internet. However, there is no mention of any type of autorebounder. Autorebounders such as U.S. Pat. No. 6,458,049B2 make it much easier to enable remote contests for two reasons. The first reason is that with a rebounder a player does not have to spend time chasing the ball. This enables the contest to focus the skill needed on shooting rather than running. Although other players may do the rebounding this would make it harder to engage in shooting because players would have to find people to rebound for them. Also even one person chasing the ball takes time away from shooting. Multiple human rebounders would be needed to remove the lag time created by chasing rebounds. Autorebounders greatly reduce or even eliminate the aforementioned problem. The second reason is autorebounders make it much easier to shoot many shots from the same location. It seems location would be an important criteria in any game model that uses shooting as the point determiner. Without a rebounder shooting from the same location becomes more difficult.

U.S. Pat. No. 4,999,603 describes Multi-Function game monitoring unit that uses a combination of sensors and visual displays to detect successful/unsuccessful shots, detecting shooting location, and display various shooting statistics. However it makes no mention of sending the information over computer networks or of using video to enable shooting contest from different locations.

### BRIEF SUMMARY OF THE INVENTION

The method utilizes autorebounders, video cameras, monitors, and communication links as main components to allow competitors to compete without being in the same location. None of the patents listed above or any other locatable combines all the above components to permit contestants to compete with each other in basketball shooting contests without being in the same physical location.

### BRIEF DESCRIPTION OF THE SEVERAL VIEWS OF THE DRAWING

FIG. 1 is a diagram of a basketball shooting system in accordance with the present invention and shows portions of two basketball shooting centers 1a, 1b.

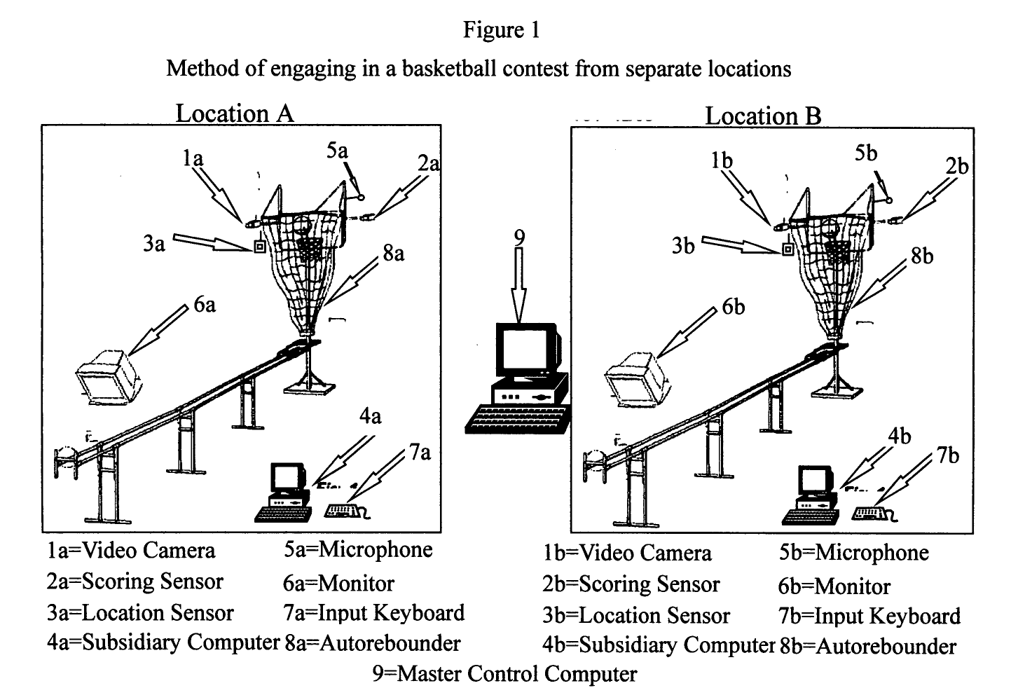

For purposes of clarity, FIG. 1 shows the elements associated with basketball shooting centers Location A and Location B.

Components of Location A

1a. Video Camera
   (Shown as mounted on backboard support of autorebounder but may be in any number of locations)
2a. Scoring Sensor
   This can be a wide variety of existing patents such as U.S. Pat. No. 4,999,603. Sensor can be eliminated and instead utilize a video analysis system such as U.S. Pat. No. 6,389,368.
3a. Location Sensor
   This sensor can also be a function of video analysis in which case it does not need to be a separate sensor, but rather a function of the video taken of the shot.
4a. Subsidiary Computer Controller
   Shown in figure as Personal Computer but in reality can be a wide variety of computers some of its functions include receiving and combining data streams from its local location then analyzing and consolidating data streams and relaying them to the central computer. Receiving data streams from central computer and passing them to monitor at local location. Also calculates shooters score and statistics at location A and merges them with incoming data streams from opposite location to display on Location A's monitor.
5a Microphone
   May be included in the video camera
6a. Display Monitor
   Receives and displays data stream from Subsidiary Computer Controller 4a
7a. Input Keyboard
   Allows for players to input data that will be stored in database.
8a. Autorebounder
   Such as U.S. Pat. No. 6,458,049 B2
      9 Master Control Computer
Receives data streams from Subsidiary Computer Controller at Location A and relays it to Subsidiary Computer Controller at Location B. Receives data streams from Subsidiary Computer Controller at Location B and relays it to Subsidiary Computer Controller at Location A. May also use video analysis to determine shot success and distance and utilize information to determine scoring. This scoring data is then transferred to relevant locations.
Also acts as database storing player profiles, player statistics and any other relevant data

Location B
1b. Video Camera
   (Shown as mounted on backboard support of autorebounder but may be in any number of locations)
2b. Scoring Sensor
   This can be a wide variety of existing patents such as U.S. Pat. No. 4,999,603. Sensor can be eliminated and instead utilize a video analysis system such as U.S. Pat. No. 6,389,368.
3b. Location Sensor
   This sensor can also be a function of video analysis in which case it does not need to be a separate sensor, but rather a function of the video taken of the shot.
4b. Subsidiary Computer Controller
   Shown in figure as Personal Computer but in reality can be a wide variety of computers some of its functions include receiving and combining data streams from its local location then analyzing and consolidating data streams and relaying them to the central computer. Receives data streams from central computer and passing them to monitor at local location. Also calculates shooters score and statistics at location B and merges them with incoming data streams from opposite location to display on Location B's monitor.
5b. Microphone
   May be included in the video camera
6b. Display Monitor
   Receives and displays data stream from Subsidiary Computer Controller 4b
7b. Input Keyboard
   Allows for players to input data that will be stored in database.
8b. Autorebounder
   Such as U.S. Pat. No. 6,458,049 B2

### DETAILED DESCRIPTION OF THE INVENTION

A method for engaging in basketball contests from different locations. The following description is for a single shooter at each of two locations although it is understood that any number of locations are possible. In addition, it is understood that contestants may participate as teams as opposed to individuals at each location or teams may be spread across multiple locations. The method consists of the following: Two locations as well as a master control computer at a third location. Location A consists of a: (1) Video Camera (2) Successful/Unsuccessful Shot Detector (3) Distance Detector (4) Subsidiary Computer controller (5) Microphone (6) Display Monitor (7) Input Keyboard (8) Autorebounder. Location B consists of the following: (1) Video Camera (2) Successful/Unsuccessful Shot Detector (3) Distance Detector (4) Subsidiary Computer controller (5) Microphone (6) Display Monitor (7) Input Keyboard (8) Autorebounder. Each location also has appropriate software as well as communications links to route the data streams along the appropriate routes. Located at a third location is a Master Control Computer and appropriate database multimedia software. It is understood that the Master Control Computer may be in one location or multiple locations possibly even as a component of the subsidiary control computers. Players enter player ID into keyboard this ID# corresponds to a player ID# in Master Control Computer relational database in which other player data is tied to ID#. Player data includes personal data as well as performance data. The central computer also acts as a booking agent and handicapper. After players enter ID# and agree to a game the computer creates a game and assigns a game ID#. This allows a game record to be created that can be queried for any number of pertinent fields. Once the game starts the individual data streams from the video camera, microphone, automatic scorer, and distance detector are sent to the subsidiary computer controller. It is understood that both the distance detector and auto scorer function may be determined by video analysis in which case they are not individual data streams by themselves but rather are a function of video analysis of the video stream at either the subsidiary computer controller or the master computer controller. After arriving at the subsidiary control computer it is relayed to either the master control computer or directly to the opposing contestants subsidiary control computer. It is then relayed to the opposing player's display monitor. At the same time the process is taking place at the other contestants location with the data flowing in the opposite direction.

It is understood that play is not limited to two individuals but may be any number of contestants for a particular game. As well teams and leagues are possible with this method.

Communication paths between different points in method may be any combination of wired or wireless schemes.

This method permits a large number of different contest models. It is not this patents intent to delineate a type of contest i.e. first shooter to twenty-five. Rather it is this patents claim to a method to allow any number of alternative shooting contests to be played without regard to physical location as long as each location has access to high-speed network connections.

1. A method of allowing basketball shooting contest to take place between two or more contestants at different locations who have access to a high speed network connection. The method utilizes autorebounders, video cameras, scoring sensors, display devices, subsidiary computer controllers, master computer controllers and appropriate communication, video analysis and database software.

2. The method according to claim one that uses communication circuits that are any combination of wired and wireless means.
